(19) United States
(12) Patent Application Publication
(10) Pub. No.: US 2018/0144373 A1
(43) Pub. Date: May 24, 2018

(54) DEVICES, SYSTEMS AND METHODS RELATING TO CONVEYING MESSAGES ON MOBILE COMMUNICATIONS DEVICES

(71) Applicant: Andrew Robertson, Sandy, UT (US)

(72) Inventor: Andrew Robertson, Sandy, UT (US)

(21) Appl. No.: 15/818,606

(22) Filed: Nov. 20, 2017

Related U.S. Application Data
(60) Provisional application No. 62/424,035, filed on Nov. 18, 2016.

(51) Int. Cl. G06Q 30/02; G06F 1/16; G06K 19/06

(52) U.S. Cl. CPC G06Q 30/0273; G06K 19/06028; G06F 1/1626

(57) ABSTRACT

Communications systems comprising a mobile communication device having an outwardly visible display such as a casing or display screen that comprises a selectively removable outwardly visible selected message thereon. The outwardly visible selected message can be selectively removable so that a user need not display the message at all time, but only when he or she desires. There can be an alert mechanism to determine and report if the outwardly visible selected message is not outwardly visible. The user can receive compensation for displaying the outwardly visible selected message, or when other users have acquired an offer of products or services from the system, which can be monitored for display time and/or display effectiveness and the compensation adjusted accordingly.

The present application claims the benefit of copending U.S. Provisional Patent Application Ser. No. 62/424,035, filed Nov. 18, 2106, which application is incorporated herein by reference in its entirety.

### BACKGROUND

Conveying messages, such as for example for advertising promoting products, or showing team or community spirit, has long been a focus of a variety of media. However, particularly in the current age of on-demand media, near-ubiquitous mobile communication devices such as cell phones and tablets, etc., it has become increasingly difficult to convey such messaging without a potential consumer turning off the message or simply turning away from the message.

Thus, there has gone unmet a need for improved methods of conveying messages, and in particular messages conveyed on mobile communications devices.

The present systems and methods, etc., remedy these issues and/or provide other advantages.

### SUMMARY

The present devices, systems and methods, etc., herein provide unique message conveyance approaches that, for example, advantageously use the seemingly ubiquitous mobile communication devices such as cell phones, tablets such as iPads®, etc., that are carried by almost everyone. For example, the current devices, systems, methods, etc., turn such mobile communication devices into outwardly visible messaging systems, and in turn provide for users (“users” includes persons owning the device, actually handling the device or persons or entities otherwise designated to receive the compensation) of such devices to receive compensation from an advertiser or other sponsor (i.e., a third-party sponsor) for displaying such messages. Thus, the current devices, systems, methods, etc., provide a win-win situation where all of advertisers, messagers and messengers, on the one hand, and users of mobile communication devices, on the other hand, benefit.

In some embodiments of exemplary systems herein a communications system comprises a mobile communication device having an outwardly visible display such as a casing or display screen that comprises an a selectively removable outwardly visible selected message thereon. The outwardly visible selected message can be selectively removable so that a user need not display the message at all times, but only when he or she desires. The communications system further can comprise an alert mechanism configured such that it can determine if the outwardly visible selected message is not outwardly visible relative to the mobile communication device. If so, then the alert mechanism sends an alert to a third party, such as a third-party sponsor 12 of the displayed image, of the separation. This can be batched or real time. The user can receive compensation for displaying the outwardly visible selected message, which can be monitored for display time and/or display effectiveness and the compensation adjusted accordingly.

These and other aspects, features and embodiments are set forth within this application, including the following Detailed Description and attached drawings. Unless expressly stated otherwise, all embodiments, aspects, features, etc., can be mixed and matched, combined and permuted in any desired manner. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE FIGURES

FIG. 1 depicts a schematic drawing showing one embodiment of possible connections between various exemplary elements of the systems herein.

FIG. 2 depicts a drawing of a logo display system herein showing a potential placement location for the selected message(s) as discussed herein.

FIG. 3 depicts a flow diagram of one embodiment for implementing the systems, methods, etc., discussed herein.

### DETAILED DESCRIPTION

The present systems, devices and methods, etc., provide approaches of conveying messages such as logos on mobile communications devices.

The methods comprise, for example, attaching, such as by displaying, connecting, inserting or adhering, an outwardly visible selected message onto a mobile communications device. This can be done, for example via either, or both, an outwardly visible casing and/or a display screen of a mobile communication device such as a smart phone, iPad®, tablet computer, or laptop computer. In the instance of attachment to an outwardly visible casing, such attachment can be achieved using permanent or non-permanent glues, magnets, hook-and-loop devices such as VELCRO®, mechanical attachers such as clips, or printing or etching onto a detachable visible casing, and/or by providing an outer casing configured to be attached to a mobile communications device with the outer casing comprising a permanent or non-permanent outwardly visible selected message. The outwardly visible casing is typically an exterior housing of the mobile communication device but it can also be, e.g., a sticker or decal on such an exterior housing or a secondary external casing configured as a protective, removable rugged outer casing; such are often available on the after-market and can be, for example, removably added to the mobile communications device for snapping on an elasticized casing that encompasses some or all of the mobile communications device.

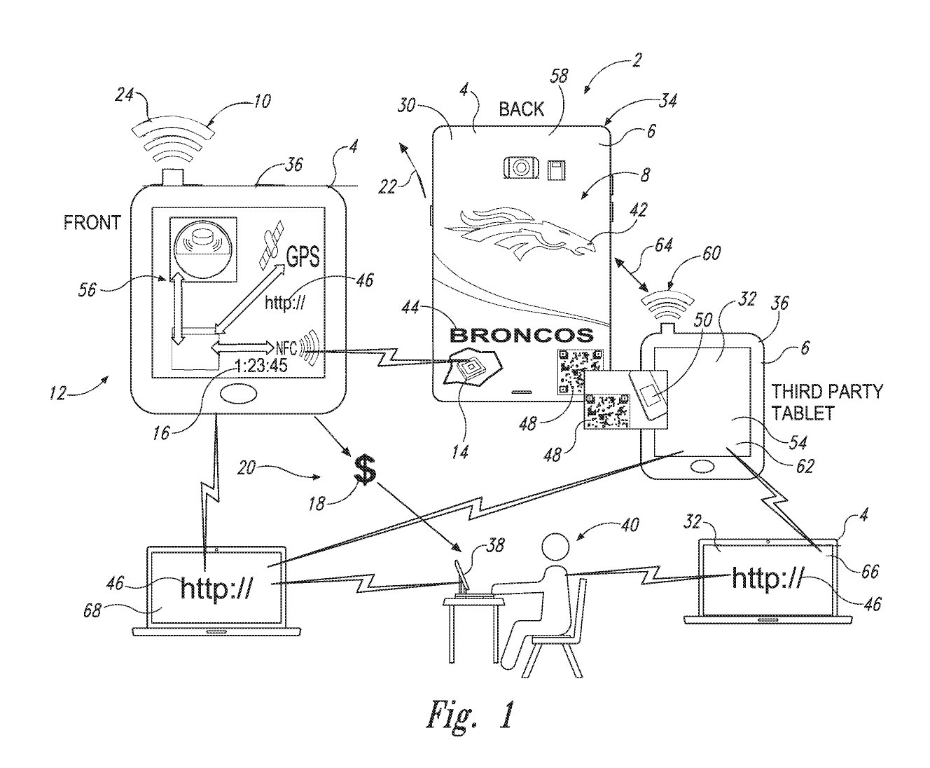

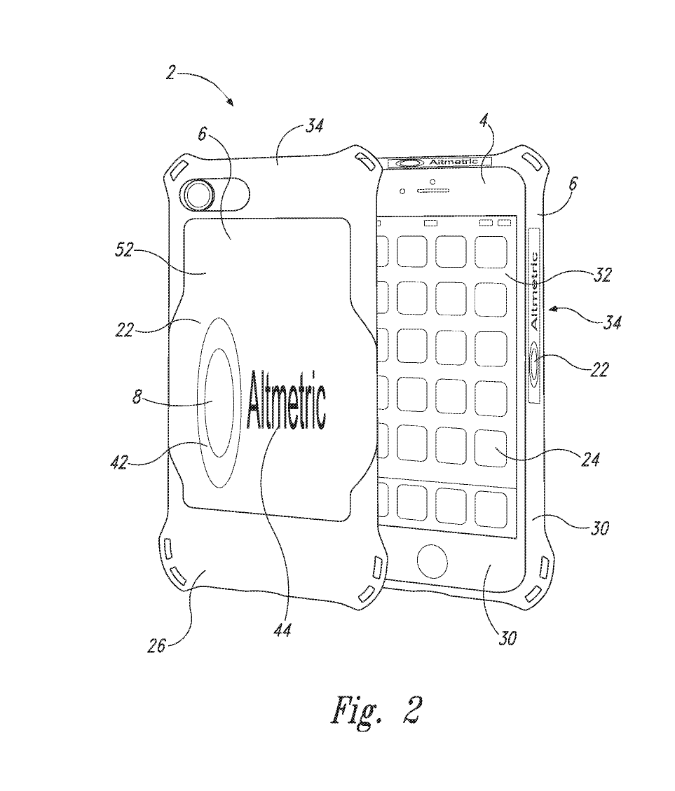

Turning to the Figures, FIG. 1 depicts a schematic drawing showing one embodiment of possible connections between various exemplary elements of the systems herein, and FIG. 2 depicts a drawing of a logo display system herein showing a potential placement location for the selected message(s) as discussed herein. In these Figures, communications system 2 can comprise a mobile communication device 4 having an outwardly visible casing 6 can comprise an outwardly visible selected message 8 thereon, the communications system 2 further can comprise an alert mechanism 10 configured such a positioning of the outwardly visible selected message 8 such that it can be not outwardly visible relative to the mobile communication device 4 triggers the alert mechanism 10 to send an alert 24 to a third-party sponsor 12 of the separation.

The positioning of the outwardly visible selected message 8 can be such that it is not outwardly visible can comprise separating the outwardly visible casing 6 from the mobile communication device 4. The communications system 2 further can comprise a recording mechanism 14 configured to record an amount of display time 16 that the outwardly visible message can be displayed by the mobile communications device 4; the recording mechanism 14 can be disposed within or attached to the mobile communications device 4 and the communications system 2 further sends the amount of display time 16 to the third party 12.

The amount of display time 16 can be determined by determining an amount of time the outwardly visible selected message 8 can be outwardly visible relative to the mobile communication device 4, or by determining an amount of time the outwardly visible casing 6 is attached to the mobile communications device 4, or for the amount of time the display screen 32 showing the outwardly visible selected message 8 is properly activated, and preferably visible for example by detecting closure of a case holding the mobile communication device 4, or ambient light or the orientation of the mobile communication device 4.

The communications system 2 further can comprise a compensation mechanism 20 configured such that a user 40 of the mobile communication device 4, or other designated party 54, receives compensation 18 for outwardly displaying 22 the outwardly visible selected message 8. The communications system 2 can be configured such that triggering an alert 24 can reduce the compensation 18 to the user 40 such as a user-designated other party 54.

The outwardly visible casing 6 can be a removable secondary casing 26 (FIG. 2) attached to the mobile communications device 4, or an exterior housing 30 of the mobile communication device 4.

In another aspect, the communications system 2 can comprise a mobile communication device 4 wherein an outwardly visible selected message 8 can be temporally displayed on a display screen 32 or display screen on back of casing 52 (FIG. 2) of the mobile communication device 4, the communications system 2 further can comprise an alert mechanism 10 configured such that terminating display of the outwardly visible selected message 8 on the display screen 32 triggers the alert mechanism 10 to send an alert 24 to a third party 12 of the termination.

The communications system 2 further can comprise a recording mechanism 14 configured to record the amount of display time 16 the outwardly visible selected message 8 is displayed on the display screen 32 and the communications system 2 transmits amount of display time 16 to a third party 12. The termination can be achieved by removing the outwardly visible selected message 8 from the outwardly visible display screen 32, and the recording mechanism 14 can be disposed within or attached to the mobile communications device 4. The communications system 2 further can comprise a compensation mechanism 20 configured such that a user 40 of the mobile communication device 4 or other party 54 receives compensation 18 for the amount of display time 16 for the outwardly visible selected message 8. The communications system 2 can be configured such that triggering the alert 24 can reduce the compensation 18 to the user 40. The mobile communication device 4 can be at least one of a mobile smart phone 34, a tablet 36 or a laptop computer 38. The mobile smart phone 34 (or other mobile communications device) typically has a front 56 and a back 58.

The outwardly visible selected message 8 can comprise at least one of a logo 42, a brand name 44, a QR or UPC code 48 (or other types of code), or a url 46. The outwardly visible selected message 8 can also comprise an individualized symbol 50 that identifies an individual mobile communication device 4 to a third party 12.

If desired, the communications system 2 can comprise a sharing mechanism, which can include payment of compensation 18 to the user 40, or other designated party, as a commission for achieving or obtaining a “share” 64 with a compensation 18 to the user 40 of the mobile communication device 4 when an offer acquired from the user's mobile communication device 4 is redeemed by the third-party mobile communication device 62 and/or third-party user under such sharing mechanism. Redeeming or other acceptance of an offer can be implemented through an third-party sponsor's and/or advertiser's web-site 66. Such “sharing” can be effected manually (e.g., the third-party simply looks at the outwardly visible selected message 8 then takes some sort of trackable action such as entering or activating a one-time code or coupon), or automated. For an example of an automated “share”, the communications system 2 can further comprise a third-party mobile communication device 62 associated with a third-party user, here a tablet 36, and the third-party mobile communication device 62 can scan the outwardly visible selected message 8 using a scanning beam 60. In some embodiments, such scanning can include establishing a link between one or more of the various devices already in the system and third-party mobile communication device 62, and can provide for compensation to the third-party mobile communication device 62 (or user, owner, etc., of such device). The “share” 64 can also be initiated via a sharing-output device located in mobile communication device 4, or otherwise as desired. The “share” 64 can comprise any desired information, for example transmitting a copy or facsimile of the outwardly visible selected message 8 from mobile communication device 4 to third-party mobile communication device 62 so that the third-party mobile communication device 62 can itself display the outwardly visible selected message 8 and receive compensation from the sponsor or other originator. The “share” 64 can also comprise instigating the third-party mobile communication device 62 (or user of such device) to take further actions such as uploading a code or url related to the advertising or other outwardly visible selected message 8, or purchasing the advertiser's products or services. The compensation 18 to the user 40 of the mobile communication device 4 when an offer acquired from the user's mobile communication device 4 is redeemed by the third-party user or other entity, etc. Information developed from or arising from the interactions between the parties, or otherwise exchanged between the parties can be aggregated. The aggregation can be done, for example, at an aggregator's web-site 68 or internally with a mobile communications device 4 or otherwise as desired.

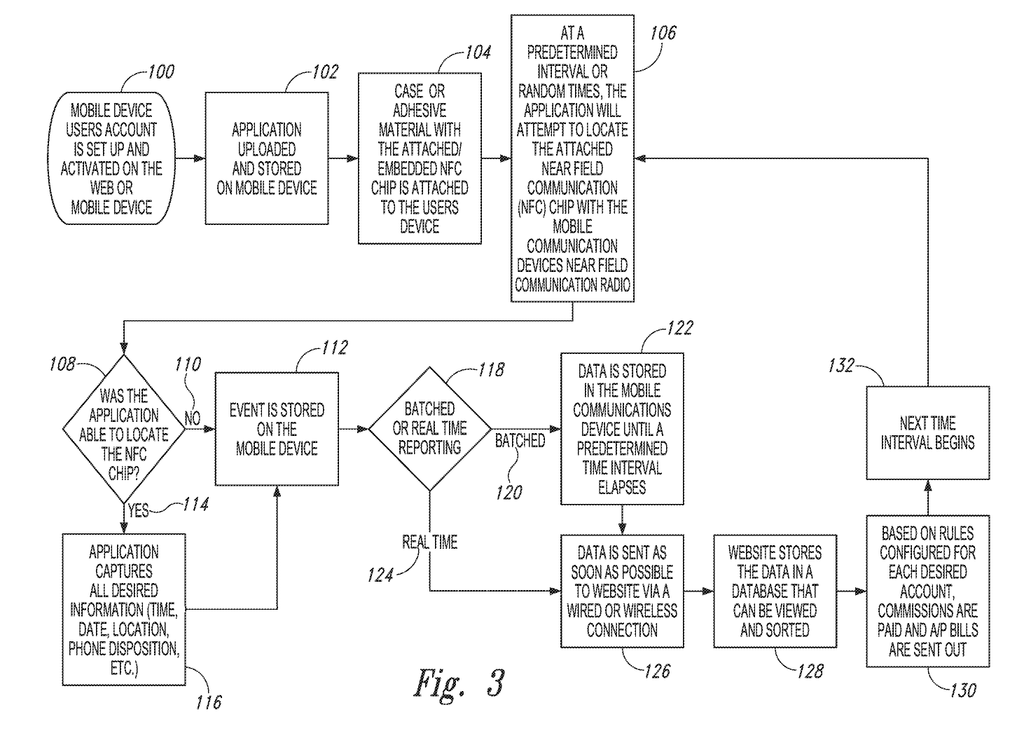

FIG. 3 depicts a flow diagram of one embodiment for implementing the systems, methods, etc., discussed herein. In FIG. 3:
100: The mobile device user's account is set up and activated, for example on the web or using a mobile device.
102: An application to implement the systems and methods herein is uploaded and stored on mobile device.
104: A case or adhesive material associated with the attached/embedded NFC chip is attached to or otherwise associated with the user's mobile communication device; alternatively, the display screen with the outwardly visible selected message can be activated.
106: At a predetermined interval or random times or otherwise as desired, the App will attempt to locate the attached or associated NFC chip or other display-tracking device with the mobile communication device's NFC radio.
108: Was the application able to locate the NFC Chip or otherwise confirm that the outwardly visible selected message has been/is displayed.
If no 110, then the Event is stored on the mobile device 112.
If yes 114, then the Application captures all desired information (e.g., time, date, location, phone disposition/orientation, etc.), 116. The Event is stored on the mobile device 112.
118: The result is then sent for batched or real-time reporting.
If batched 120, then the data is stored in the mobile communications device until a predetermined time interval elapses or the data is otherwise called upon 122.
If real time 124 then the data is sent as soon as possible to website via a wired or wireless connection 126.
128: Next, the website or other storage location stores the data in a database that can be viewed and sorted as desired.
130: Based on rules configured for each desired account, commissions are paid and A/P Bills are sent out.
132: The next time interval begins, for example by returning to Step 106

Turning to a general discussion of the aspects and embodiments herein, the outwardly visible casing comprises the selected message, such as an outwardly visible artistic design, thereon. Examples of such messages include e.g., a logo, brand name, url, UPC code, etc. The selected message can be a generally recognized item or an individualized symbol that identifies an individual mobile communication device or service/product. The casing is removably or permanently attached to the mobile communication device and the methods and systems further comprise providing an alert mechanism such as a proximity sensor such as a contact sensor, Bluetooth®, near field communication, or passive or active system, configured such that separating the casing or advertising mechanism from the mobile communication device triggers an alert to a third-party sponsor of the separation; the alert can be contemporaneous with the separation or provided otherwise as desired, such as at a pre-set interval or as a record of past absence of the selected message. As used herein, “passive sensor system” indicates a proximity sensor that does not independently send out a proximity signal but instead responds to a “ping” from an interrogative unit asking for confirmation (or not) of proximity of the sensor/attached item to its mobile communications device, e.g., proximity of the selected message to its mobile communication device. Such a device need not have a self-contained power source. An “active sensor system” indicates a proximity sensor that independently sends out a proximity signal to an interrogative unit, i.e., it sends out a signal of its own accord and may have an independent power source (or it can take advantage of local, available power sources such as the power source for its mobile communication device. An active sensor system can also respond to a “ping” from an interrogative unit asking for confirmation (or not) of proximity of the sensor/attached item to its mobile communications device.

For a selected message be within “proximity” to its “home” mobile communication device, the selected message must be readable by an individual looking at the mobile communication device, typically without visual interference by any physical item attached to the mobile communication device.” Thus, “proximity” as used herein typically indicates that the selected message is in physical contact with the mobile communication device, or within at least about ½″, 1″, 2″, 3″ or 6″, or within about 1, 2 or 3 feet.

The presence/absence of the selected message can also be detected, for example, via an application or other device on the phone attempting, possibly periodically or according to a schedule, to confirm the presence of the selected message such as by seeking to communicate with/detect the selected message (or a device associated therewith). In other words, the confirmation of the presence of the selected message can be initiated by either a device adjacent or attached to the selected message (including the selected message itself) and/or by the mobile communication device, or by any other suitable system for proximity verification.

In certain embodiments, the methods and systems are configured such that a user of the mobile communication device, or some other designated person or entity, receives compensation for outwardly displaying the artistic design/logo etc. Such compensation can include but not limited to redemption by a user of offers or discounts made available from an entity benefitting from the display of the selected message, an unrelated retailer selling products or services, a trademark owner, etc. The methods and systems can also be configured such that triggering the separation alert reduces the compensation to the user: the compensation could be lessened, eliminated or there could even be negative compensation (i.e., the user would pay the sponsoring third party). For example, if a user desires to remove the selected message for a period of time, the compensation provided to such user would be reduced pro rata for the non-connected/adhered time. Further, where the selected message is displayed on a cell phone case, the system can be configured to avoid triggering an alert if the separation is less than a desired amount of time, for example, if the case is removed after the phone is dropped in water so that the phone can be dried. Such non-triggering events can be temporally defined at any desired length of time, for example about 30″, 1′, 2′, 5′, 10′, 15′, 20′ or 30′.

Detection of proximity can be detected, for example, either instantly when the mobile communication device is separated from the selected message, which may require constant or very frequent communication with the selected message, which might be a battery power issue in some embodiments, or through the periodic, scheduled and/or randomized proximity verification which if desired can be effected via an application (app) on the mobile communication device, on a proximity sensor, etc., which can allow for non-energy use between such verifications.

Examples of such proximity sensors or systems include any suitable device or system including for example both passive and active devices, for example a Bluetooth® sensor, RFID Chip, and near field communications systems; such systems can also comprise, and/or be implemented via, an application (app) on the mobile communication device. Such sensors can be attached to, built into or inserted into the outer casing or held on by an adhesive material, or otherwise as desired. Such sensor communicates the presence, absence, proximity, etc., of the selected message to a third-party sponsor. This can be done, for example, by an application (app) on the mobile communication device, or by a communication device attached to or in close physical proximity, to the outer casing, such as via a wireless or wired connection. In some embodiments, the smartphone or other communications device can then receive information from the RFID chip or other type of proximity indicating system to confirm that the selected message is still displayed, for example because the case or adhered material is still in very close physical proximity to the smartphone. Such can be effected via a wired or wireless connection via an application on the smart phone or a sensor.

If desired, the sensor—or other devices or systems associated with the mobile communications device—can also report to the third-party sponsor other pieces of information such as but not limited to, exposure to light, movement(s), location(s) or disposition(s) of the mobile communication device (such as whether the mobile communication device is on its back/front/side) so that the quality of the exposure of the selected message can be approximated, for example based on such location(s), etc., in which the device has been present.

Electronic/digital devices can also be provided to establish selected messages on an outwardly facing display element of the mobile communications device, such as a display screen or display projector (e.g., a flat display or holographic display), and then the comparable tracking, alerts, etc., and even compensation, can be applied as well. In such embodiments, the projected image can be more than 6″, 3′ away from the mobile communications device, indeed can be set as far away as the projector can reach.

In one embodiment, a use for the methods, systems, etc., for this process is to allow advertisers to confirm that the outwardly displayed message (whether on the case, adhered material or display screen) is at the least present on the device and if desired also if it's being displayed, the locations it has been displayed in, the disposition of the mobile device and the length of time of the display.

In the case of advertising, the selected messages can be, for example, marketing brands, QR or UPC or other types of codes, URLs, coupons, or other images or messages to identify the company or product/service being advertised. Such can also verify that the advertiser's logo, etc., is still attached, adhered, in close physical proximity to, connected to or otherwise displayed on/by the mobile device. This confirmation allows the advertiser to pay a commission to the user of the mobile communications device, etc., in exchange for displaying the advertiser's Logo, Marketing Brand, coupon or other image. The compensation can also be paid in exchange for designated activities that are initiated or occur based on the outwardly visible selected message. In the case of offers, etc., that are shared with other parties via the system (e.g. visually, by scanning, or other sharing mechanism), a commission can be paid to the owner, or his or her designated party of the mobile communication device, for example when an offer acquired from the user's mobile communication device is redeemed.

If desired, the advertiser or other third-party sponsor collecting the information can also aggregate the display data, connect/disconnect data, etc., from the user's mobile communication device and report it or otherwise deliver it to the advertiser, for example in real-time, or at pre-arranged (scheduled) or random intervals. The third-party sponsor can also aggregate the data and then use such aggregated data for other purposes such as targeting advertising to the mobile device owner or other users, or to those persons and entities that the user comes in contact with. This can be based, for example, on locations visited and/or from information requested from the user (such as surveys or questionnaires). The third-party sponsor can also ask the user's mobile communication device, or the user, to confirm the legibility of the outwardly visible selected message. This can be done, for example, by requesting that the user provide a picture or other form of verification that the message is legible and/or still attached to the mobile device. The third-party sponsor can also transmit the aggregated data to an outside third-party.

The third-party sponsor can also aggregate the data and then use such aggregated data for other purposes such as targeting advertising to the mobile device owner or other users, or to those persons and entities that the user comes in contact with. This can be based, for example, on locations visited and/or from information requested from the user (such as surveys or questionnaires). The third-party sponsor can also ask the user's mobile communication device, or its user, to confirm the legibility of the outwardly visible selected message. This can be done, for example, by requesting that the user provide a picture or other form of verification that the message is legible and/or still attached to the Mobile device.

The present application is further directed to methods of making the various elements of the systems and apparatus herein, including making the systems and apparatus themselves from such elements, as well as to methods of using the same, including for example applying the logo display systems to mobile devices, manipulating the various elements of the logo display systems, and removing partially or completely the logo display systems from a mobile device, or otherwise as desired.

Various aspects, features and embodiments are set forth within this application, including this Detailed Description and attached drawings. Unless expressly stated otherwise, all embodiments, aspects, features, etc., can be mixed and matched, combined and permuted in any desired manner.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

What is claimed is:

1. A communications system comprising a mobile communication device having an outwardly visible casing comprising an outwardly visible selected message thereon, the communications system further comprising an alert mechanism configured such that positioning the outwardly visible selected message so that is not outwardly visible relative to the mobile communication device triggers the alert mechanism to send an alert to a third-party sponsor of the separation.

2. The communications system of claim 1 wherein the positioning of the outwardly visible selected message such that it is not outwardly visible comprises separating the outwardly visible casing from the mobile communication device.

3. The communications system of claim 1 wherein the communications system further comprises a recording mechanism configured to record an amount of display time the outwardly visible selected message is displayed by the mobile communication device.

4. The communications system of claim 1 wherein the communications system further comprises a recording mechanism configured to record an amount of time the outwardly visible selected message is attached to the mobile communication device or casing.

5. The communications system of claim 4 wherein the recording mechanism is disposed within the mobile communication device and the communications system further sends the amount of display time to the third-party sponsor.

6. The communications system of claim 5 wherein the amount of display time is determined by determining an amount of time the outwardly visible selected message is outwardly visible relative to the mobile communication device.

7. The communications system of claim 6 wherein the amount of display time is determined by determining an amount of time the outwardly visible casing is attached to the mobile communication device.

8. The communications system of claim 1 wherein the communications system further comprises a compensation mechanism configured such that a user of the mobile communication device, receives compensation for outwardly displaying the outwardly visible selected message.

9. The communications system of claim 1 wherein the communications system further comprises a compensation mechanism configured such that a user of the mobile communication device receives when a share involving the outwardly visible selected message is initiated or occurs between the mobile communication device and a third-party mobile communication device.

10. The communications system of claim 9 wherein the share comprises an offer of products or services from the third-party sponsor to a user of the third-party mobile communication device.

11. The communications system of claim 10 wherein the communications system is configured such that triggering the alert reduces the compensation to the user.

12. The communications system of claim 1 wherein the outwardly visible casing is a removable secondary casing attached to the mobile communication device.

13. The communications system of claim 1 wherein the outwardly visible casing is a permanent secondary casing attached to the mobile communication device.

14. The communications system of claim 1 wherein the outwardly visible casing is an exterior housing of the mobile communication device.

15. A communications system comprising a mobile communication device wherein an outwardly visible selected message is temporally displayed on a display element of the mobile communication device, the communications system further comprising an alert mechanism configured such that termination of the display of the outwardly visible selected message on the display screen triggers the alert mechanism to send an alert to a third-party sponsor of the termination.

16. The communications system of claim 15 wherein the communications system further comprises a recording mechanism configured to record the amount of display time the outwardly visible selected message is displayed on the display screen and the communications system transmits amount of display time to the third-party sponsor.

17. The communications system of claim 15 wherein the termination is achieved by removing the outwardly visible selected message from the outwardly visible display screen.

18. The communications system of claim 16 wherein the recording mechanism is disposed within or attached to the mobile communication device.

19. The communications system of claim 15 wherein the communications system further comprises a compensation mechanism configured such that a user of the mobile communication device receives compensation for the amount of display time for the outwardly visible selected message.

20. The communications system of claim 15 wherein the communications system further comprises a compensation mechanism configured such that a user of the mobile communication device receives when a share involving the outwardly visible selected message is initiated or occurs between the mobile communication device and a third-party mobile communication device.

21. The communications system of claim 20 wherein the share comprises an offer of products or services from the third-party sponsor to a user of the third-party mobile communication device.

22. The communications system of claim 15 wherein the communications system is configured such that triggering the alert reduces the compensation to the user.

23. The communications system of claim 1 wherein the outwardly visible selected message comprises at least one of a logo, a brand name, brand messaging, a url, or a UPC code or an offering for a service or product.

24. The communications system of claim 1 wherein the outwardly visible selected message comprises an individualized symbol that identifies an individual mobile communication device to a third-party sponsor.

25. The communications system of claim 1 wherein at least a quantity of display-time for the outwardly visible selected message is collected and recorded.

26. The communications system of claim 25 wherein at least display data, connect/disconnect data, etc., from the user's mobile communication device is collected and aggregated to provide aggregated data.

27. The communications system of claim 26 wherein aggregated data is transmitted to the third-party sponsor.

28. The communications system of claim 27 wherein the third-party sponsor requests the user's mobile communication device or a user of the mobile communication device to confirm legibility of the outwardly visible selected message.

29. A method of making, the method comprising making the communications system of claim 1.

30. A method of using, the method comprising using the communications system of claim 1.
